(19) United States
(12) Patent Application Publication
(10) Pub. No.: US 2006/0021946 A1
(43) Pub. Date: Feb. 2, 2006

(54) Method and material for water treatment

(76) Inventors: Carl Hensman, Seattle, WA (US); Michael Ramage, Seattle, WA (US)

Correspondence Address: Robert A. Jensen;Jensen & Puntigam, P.S., #1020, 2033 6th Ave., Seattle, WA, 98121, US

(21) Appl. No.: 11/217,535

(22) Filed: Sep. 1, 2005

Related U.S. Application Data
(63) Continuation-in-part of application No. 10/726,955, filed on Dec. 3, 2003, now abandoned.
(60) Provisional application No. 60/500,668, filed on Sep. 5, 2003.

(51) Int. Cl. C02F 1/28

(52) U.S. Cl. 210/688

(57) ABSTRACT

The disclosed invention relates to the use of a volcanic rock mined from an unwelded ash flow tuff to remove toxic metals from contaminated aqueous solutions. The material absorptive properties can also be enhanced using a combination of zero valent iron, oxidized iron derivatives and activated carbon to create a binding system.

The present invention is a continuation-in-part from Ser. No. 10/726,955, filed Dec. 3, 2003, which claimed priority from provisional application 60/500,668, filed Sep. 5, 2003 by Carl Hensman and Michael D. Ramage. This application relates to the cleaning or purifying of contaminated aqueous systems, where the aqueous system is contaminated with toxic metals or metalloids. More specifically, the toxic metals or metalloids are immobilized by ex-situ or in-situ treatment with a mineral substrate modified by oxidized iron derivatives.

### TECHNICAL FIELD

### BACKGROUND OF THE INVENTION

There are over 30 toxic metals and metalloids, as defined by The U.S. Environmental Protection Agency (USEPA). These toxic metals include, but are not limited to, Arsenic, Hexavalent Chromium, Lead, Cadmium, Mercury, Nickel, Copper, Zinc, Silver and Selenium. These metals are introduced into the environment and into the watershed via industrial discharge and natural translocation. Regulations determining toxic metal concentrations in aqueous systems, whether they be industrial, municipal or environmental, on water quality are becoming more stringent. Additionally, more information is reported daily on the toxic effects of water contaminants.

As such, a great focus has been placed on designing methods that can remove the toxic metals from the wastewater in a simple and cost effective manner. Many problems exist with current treatment technologies. Precipitation treatment typically requires the addition of large quantities of treatment chemicals to the aqueous system to remove toxic metals at lower than parts per million (ppm) concentrations. This ultimately results in a high volume of toxic metal laden solid waste. Ion-exchange materials have been developed in an attempt to circumnavigate the waste solid volume problem. The iron-exchange materials are normally implemented as an adsorbent bed or filter. However, due to the production cost these materials have limited practical use in low volume-flow systems, and are often used in a ‘polishing’ capacity after another treatment technique removes the bulk of the toxic metals. Many laboratories have endeavored to develop an effective, yet cost effective, material that can be implemented as a permeable bed, thus removing the capital cost of separation equipment, or allowing small scale implementation at point of source or point of use. Unfortunately, as the allowed concentrations of contaminants in the aqueous systems is reduced, more emphasis is placed on the chemical interactions between individual contaminate species and the treatment chemistry. For example, in a simple ferric hydroxide precipitation system or ion-exchange system arsenate will be adsorbed and removed by the precipitate, but arsenite or organic-As will not. This leads to more complex systems where pretreatment of the aqueous system is required, to force all the contaminant species into a treatable form.

One material that has shown promise and has been the focus of many patents is iron as an oxidized iron derivative, a mineral and in the zero valent (metallic) form. All these variants of iron have unique properties, but the principal component is the active iron surface area that is in contact with the aqueous system.

Prenger et al¹ use magnetite, a mineral with a high content of ferric oxide and a large surface area, for adsorption of heavy metals. The magnetite is not as effective as some minerals at adsorbing heavy metals, but it has the advantage that it can be removed from the aqueous stream by a magnetic system.
¹ U.S. Pat. No. 6,596,182 July, 2003 Prenger et. al. 210/798

Harrison² describes the use of clays derived from basalt weathering for ion exchange remediation. The Mg and Fe ions, contained in the clays are exchanged for the target heavy metals.
² U.S. Pat. No. 4,872,993 October, 1989 Harrison 210/666

Benjamin et al³⁴ use olivine, a ferric oxide mineral found in basalt, as the precursor to a granular ferric oxide treatment mineral. However, neither patent considers the direct use of basalt with the aqueous system, thus no appreciation can be made for the ability of basalt to directly adsorb toxic metals from the aqueous systems.
³ U.S. Pat. No. 5,911,882 June 1999 Benjamin et. al. 210/679

⁴ U.S. Pat. No. 5,369,072 November 1994 Benjamin et. al. 502/84

As in the patent awarded to Benjamin et al several patents consider the use of ferric hydroxide precipitation by pH adjustment. Azizian⁵ saturated activated alumina or bauxite in an aqueous ferric salt solution and then used sodium hydroxide to complete hydrolysis, forming an insoluble hydrated ferric oxide on the surface of the ore. This product was then used for water treatment for contaminants.
⁵ U.S. Pat. No. 6,599,429 July, 2003 Azizian 210/681

Barkatt et al⁶ precipitated hydrated ferric oxide in a contaminated aqueous system and then applied pressure to form a protective oxidized coating on a metal surface or a ceramic.
⁶ U.S. Pat. No. 6,084,146 July, 2000 Barkatt et. al. 588/10

Krulik et al⁷ precipitate arsenic and fluoride from aqueous solution using a combination of Ca and ferric or aluminum salts, followed by pH adjustment to form the precipitate and then filtration to remove the precipitate from solution.
⁷ U.S. Pat. No. 6,613,230 September, 2003 Krulik et. al. 210/638

The Bonnin⁸ patent claims to saturate chabazite in ferrous sulfate, drying the product and demonstrating its use for arsenic remediation. The product is shown to work well, however, it is most likely that the Fe on the chabazite is in the ferric form and not the highly unstable ferrous form as claimed, which after drying will adopt a ferric oxide or hydrated ferric oxide configuration.
⁸ U.S. Pat. No. 6,042,731 March, 2000 Bonnin 210/679

Brewster⁹ cleverly constructs an electrochemical cell that generates ferrous ions, which under oxidizing conditions forms hydroxy ferric oxide. Any arsenic present is expected to oxidize to arsenate under these conditions, forming an insoluble complex of the afore-mentioned components.
⁹ U.S. Pat. No. 5,368,703 November, 1994 Brewster 205/508

All of the above techniques are dependent on the target metal forming co-precipitates, mixed precipitates and/or adsorption to oxidized iron derivatives. (Manceau¹⁰, Benjamin¹¹, Lo¹², Hering¹³, Lai¹⁴, Ryan¹⁵, Lai¹⁶)
¹⁰ Manveau et. al. “The mechanism of anion adsorption on iron oxides: Evidence for the bonding of arsenate tetrahedral on free Fe(O,OH)₆ edges” Geochim. Cosmochim. Acta, Vol. 59, No. 17, pp. 3647-3653, 1995

¹¹ Benjamin et. al. “Sorption and filtration of metals using iron-oxide-coated sand” Wat. Res., Vol. 30, No. 11, pp. 2609-2620, 1996

¹² Lo et al “Adsorption of Se(IV) and Se(VI) on an iron-coated sand from water” Chemosphere, Vol. 35, No. 5, pp. 919-930, 1997

¹³ Hering et. al. “Arsenic removal from drinking water during coagulation” J. Environ. Eng., August, 1997

¹⁴ Lai et al “Evaluating an iron-coated sand for removing copper from water” Wat. Sci. Tech., Vol. 30, No. 9, pp. 175-182, 1994

¹⁵ Ryan et. al. “Effect of solution chemistry on clay colloid release from an iron oxide-coated aquifer sand” Environ. Sci. Technol., Vol. 28, pp. 1717-1726, 1994

¹⁶ Lai et al “Competitive adsorption of copper and lead ions on an iron-coated sand from water” Wat. Sci. Tech., Vol. 42, No. 3-4, pp. 149-154, 2000

Not bound by theory, it is understood that the removal of metal contaminates by zero valent iron has many avenues, but all are based on the reductive environment at the zero valent iron surface. For example, it has been shown that chromate is rapidly reduced by zero valent iron to Cr^{3+ 17}, which then precipitates from solution as chromium hydroxide or CrₓFe₁₋ₓ(OH)₃. It has also been shown that zero valent iron can reduce Cu²⁺, Ag⁺ and Hg²⁺, to their metallic forms.¹⁸ Thermodynamically, zero valent iron should also be able to reduce the mobile TcO⁻⁴, UO₂⁺² and molybdenate immobile species. Additionally, zero valent iron is expected to complex As and form arsenopyrites under anaerobic conditions, as clearly described by Nikoladis et. al.¹⁹ The zero valent iron is initially reduced to the ferrous form, with further reduction of the ferrous form to ferric. The iron oxidation is typically concurrent with water hydrolysis, sulfate reduction and arsenate reduction. This results in ferric hydroxide, scorodite and arsenopyrites, among other species, which are insoluble and thus precipitate from solution.
¹⁷ Gould “The kinetics of hexavalent chromium reduction by metallic iron”, Wat. Res. 16, pp. 871-877, 1982

¹⁸ Gould et. al. “Recovery of silver and mercury from COD samples by iron cementation”, J. Wat. Pol. Con. Fed., 56 pp. 280-286, 1984

¹⁹ U.S. Pat. No. 6,132,623 October 2000, Nikiladis et. al. 2000 210/719

Nikolaidis et al used this chemical process to claim a patent award for arsenic remediation by mixing sand with zero valent iron particles. The sand/zero valent iron mixture has an intended use as either a filter medium or a subsurface reactive barrier. However, if a mixture of iron filings and sand is used the application can only be for a slow moving aqueous source. The low surface area of the iron filings results in the need for a longer contact time between the surface and the contaminated aqueous solution.

Liskowitz et al²⁰ inject an aqueous slurry of metallic iron powder directly into the contaminated aqueous reservoir, such as a ground plume or aquifer. The intention being that the Fe⁰ will precipitate the offending toxic metals in-situ, and the geochemistry will filter the precipitate.
²⁰ U.S. Pat. No. 5,975,798 November 1999 Liskowitz et. al. 1999 405/128.5

Bowman et al²¹ mixes powered zero valent iron with a powdered naturally occurring organic adsorbent, such as clinoptilolite. This mixture is then bound together using sol-gel technology to form a porous granular material. The material shows good performance in removal of certain metals and chlorinated compounds. It is unfortunate that the process creating the material is multi-step and potentially very expensive.
²¹ U.S. Pat. No. 6,261,986 July 2001, Bowman et. al. 2001 502/62

Ponder et al²² put a fascinating twist on the modification of inert support materials with zero valent iron. Where traditionally, the zero valent iron has been coated on a silicate support by saturation and drying, Ponder marinades the sand in solution containing Fe(II) salts. After a sufficient amount of time, a reducing agent, such as sodium borohydrate is introduced to the system. This reduces the ferrous ions on the sand surface to zero valent iron. The mixture is then dried. This results in a very high surface area zero valent iron coated on the sand. However, due to the lack of mass of zero valent iron the material will likely be exhausted quickly, and examples are only cited for extended time studies, i.e. the sample is contacted to the contaminated aqueous solution for several days, as such assessment cannot be made for the effectiveness on point of use systems.
²² U.S. Pat. No. 6,242,663 June 2001, Ponder et. al. 588/205

Smith²³ reports in the associated awarded patent that Fe⁰, in a particle size suitable for a permeable reactive barrier, is approximately $400 per ton, which can be expensive for large scale operations. Smith goes further, indicating that iron fillings have toxic metals associated with them that may be leached into the environment. Smith then presents a reactive barrier in which waste steel slag is used ‘as-is’, the only preparation step, being to sieve the slag for ⅛^{th} to 1 inch particle size.
²³ U.S. Pat. No. 6,602,421 August 2003, Smith 210/662

In all of the reviewed articles and awarded patents, no person has indicated the use of basalt, rhyolite or andesite from naturally occurring ashflow tuffs for removal of toxic metals from contaminated aqueous streams. No one has indicated the enhancement of the natural adsorption properties of basalt, rhyolite or andesite from naturally occurring ashflow tuffs using oxidized iron derivatives or zero valent iron. No one has indicated the enhancement of any product by combining the independent adsorption properties of oxidized iron derivatives and zero valent iron, by mixing these two materials together and combining them with a support such as basalt, rhyolite or andesite from naturally occurring ashflow tuffs.

In all of the reviewed articles and awarded patents, no person has indicated the use of recycled minerals from anthropogenic brick for removal of toxic metals from contaminated aqueous streams. No one has indicated the enhancement of the natural adsorption properties of recycled minerals from anthropogenic bricks using oxidized iron derivatives or zero valent iron. No one has indicated the enhancement of any product by combining the independent adsorption properties of oxidized iron derivatives and zero valent iron, by mixing these two materials together and combining them with a support such as recycled minerals from anthropogenic brick.

### SUMMARY OF THE INVENTION

The disclosed invention relates to the use of volcanic rock, mined from an unwelded ashflow tuff, or recycled minerals from anthropogenic brick, to remove toxic metals from contaminated aqueous solutions. The volcanic rock, or recycled minerals from anthropogenic brick, naturally contains oxidized iron derivatives. Upon contact with toxic metal contaminated aqueous solution, the volcanic rock, or recycled minerals from anthropogenic brick, adsorbs the toxic metals.

In a further aspect, the invention relates to the enhancement of the natural absorption characteristics of the volcanic rock, or recycled minerals from anthropogenic brick. This enhancement is achieved by mixing or layering a combination of zero valent iron, oxidized iron derivatives and activated carbon with the volcanic rock, or recycled minerals from anthropogenic brick, to create a binding system.

The binding system has no set combination of volcanic rock, recycled minerals from anthropogenic brick, zero valent iron, oxidized iron derivative and activated carbon. The final formulation is designed around the final application. However, prior to use the final formulation of the modified material should be heated at greater than 105° C. to dryness then re-wetted and then heated again at greater than 105° C. to dryness. This is repeated multiple times. This is postulated to improve the production of arsenic binding sites on the formulation contents and improve the production of iron oxy-hydroxides in the material.

Final applications of use may include, but are not limited to, the target metals and achieving desired toxicity characteristic leachate procedure levels of toxic metal concentrations. The contaminated aqueous solution can be passed through the binding system. The binding system may also be added to the contaminated aqueous solution as part of the treatment process. The binding system may also be added in situ, as in the example of a contaminated aquifer.

### BRIEF DESCRIPTION OF THE DRAWINGS

FIG. 1 is a graph depicting the loading of arsenic species on binding system formulation D using a increasing concentration.

FIG. 2a demonstrates a breakthrough curve for 20,000 μg/L each of arsenite and arsenate for binding system formulation C.

FIG. 2b demonstrates an equivalent breakthrough curve for 200 μg/L each of arsenite and arsenate for binding system formulation C.

FIG. 3a demonstrates a breakthrough curve for 20,000 μg/L each of arsenite and arsenate for binding system formulation D.

FIG. 3b illustrates the equivalent breakthrough curve for 200 μg/L each of arsenite and arsenate for binding system formulation C.

FIG. 4a illustrates a breakthrough curve for 20,000 μg/L each of arsenite and arsenate for binding system formulation E.

FIG. 4b illustrate an equivalent breakthrough curve for 200 μg/L each of arsenite and arsenate for binding system formulation C.

FIG. 5 illustrates the concentration of arsenic species rinsed off of binding system formulation D after it has been saturated with a 20,000 μg/L solution of arsenic species.

### BEST MODE FOR CARRYING OUT THE INVENTION

The present invention is directed to a new and improved method for the immobilization of organic and inorganic toxic metal species, such as monomethyl arsenate, arsenates and arsenites, by a volcanic rock mined from ashflow tuffs, recycled minerals from anthropogenic brick, or said minerals combined with oxidized iron derivates and zero valent iron. This combination of materials is then heated at greater than 105° C. to dryness, re-wetted and heated at greater than 105° C. to dryness. This is repeated multiple times. Henceforth defined as the “binding system”. This is postulated to improve the production of arsenic binding sites on the formulation contents and improve the production of iron oxy-hydroxides in the material. In accordance with the preset invention, a contaminated aqueous solution is contacted with the binding system. The target metals form co-precipitates, mixed precipitates and/or are adsorbed to oxidized iron derivatives, or are reduced by the zero valent iron, followed by deposition of the metal, a co-precipitate, or mixed precipitate, or form derived pyrites. The process described is abiotic and does not require the presence of biotic agents.

In the above embodiment toxic metals, which include “heavy metals,” are individual metals, semi-metallic metals, other metals and metal compounds that negatively affect the health of people. At trace levels, many of these elements are necessary to support life. However, at elevated levels they become toxic, may build up in biological systems, and become a significant health hazard. Although not limited to, as of 14 Apr. 1999 the U.S. Department of Labor, Occupational Safety & Health Administration defined toxic metals as: Aluminum, Antimony, Arsenic, Barium, Beryllium, Bismuth, Boron, Cadmium, Calcium, Chromium, Cobalt, Copper, Hafnium, Iron, Lead, Magnesium, Manganese, Mercury, Molybdenum, Nickel, Osmium, Platinum, Rhodium, Selenium, Silver, Tantalum, Tellurium, Thallium, Tin, Titanium, Uranium, Vanadium, Yttrium, Zinc, Zirconium. A contaminated aqueous solution is considered a fluid in liquid phase that contains unacceptable levels of these toxic metals.

Volcanic rocks are defined as extrusive igneous rocks. Igneous rock begins as magma. Intrusive igneous rock, for example granite, form when magma cools inside the Earth. Extrusive igneous rocks, for example basalt, form at the Earth's surface. Volcanic rocks are typically divided into four basic types according to the amount of silica (SiO2) in the rock basalt consists of about 48-52% silica andesite consists of about 52-63% silica dacite consists of about 63-68% slica rhyolite consists of more than 68% silica Other major elements in varying proportion include titanium (TiO₂), aluminum (A₂O₃), iron (FeO or Fe₂O₃), manganese (MnO), magnesium (MgO), calcium (CaO), sodium (Na₂O), potassium (K₂O, and phosphorous (P₂O₅).

In the current embodiment the volcanic rock is mined as from an ashflow tuff. Volcanic ash is composed of vitric, crystal or lithic particles (of juvenile, cognate or accidental origin) of various proportions. A tuff is the consolidated equivalent of ash. Further classification is made according to environment of deposition (lacustrine tuff, submarine tuff, subaerial tuff) or manner of transport (fallout tuff, ashflow tuff). Reworked ash (or tuff) may be named according to the transport agent (fluvial tuff, aeolian tuff). Ignimbrites form from avalanches of superheated ash and volcanic gases. Also in the mix are pieces of pumice, fragmented crystals, and occasionally rock fragments from the vent walls. The gas and ash mixture is very fluid and denser than air, so it rushes down valleys and ponds in low areas when it stops moving. The inside of the ignimbrite is well insulated by the ash around it and is very hot. The ash in the ignimbrite is made of glass shards that formed as a frothy magma blew itself apart as it erupted (as pressure is released, gas bubbles in the magma expand and ultimately rupture) The expansion helps propel material out of the vent and the rupturing of those bubbles creates three- or four-pronged shards of magma that cool quickly enough to form glass. In the hot center of the ignimbrite, then, these glass shards (the ash) are hot enough to be plastic and the weight of the ash above compacts them and they flow together and stick together to form a solid layer of glass in a process called welding. The resulting rock is called a vitrophyre and usually forms about ⅔ of the way down in the ignimbrite (ash-flow tuff) unit. On either side there will be a textural gradient from the vitrophyre through dense, non-glassy tuff (here the glass shards are still stuck together or ‘welded’, but are not as compacted), then less dense ‘partially welded’ tuff to unwelded tuff which is often loose and dusty and is typically eroded from the tops of ignimbrites soon after eruption. If the loose and dusty unwelded tuff can be captured before erosion, it presents a perfect support material for toxic metal clean up. With no modification the material will adsorb heavy metals and specific modification can enhance this activity. However, and more importantly, due to the small particulate nature the material need only be excavated and rinsed and it is in a usable form. This results in a very economical material due to the lack of preprocessing.

Anthropogenic brick is defined as any human produced conglomerate of minerals that are used for building purposes. In this instance the brick may be retained as a whole material or crushed.

The enhancement of the toxic metal absorptive characteristics of the material are achieved through the addition of zero valent iron and oxidized iron derivatives. Where zero valent iron means elemental iron. Not bound by theory, it is understood that the removal of metal contaminates by zero valent iron has many avenues, but all are based on the reductive environment at the zero valent iron surface. For example, it has been shown that chromate is rapidly reduced by zero valent iron to Cr³⁺, which then precipitates from solution as Cr(OH)₃ or CrₓFe₁₋ₓ(OH)₃. It has also been shown that zero valent iron can reduce Cu²⁺, Ag⁺ and Hg²⁺, to their metallic forms. Thermodynamically, zero valent iron should also be able to reduce the mobile TcO⁴⁻, UO₂²⁺ and MoO₄²⁻ immobile species. Additionally, zero valent iron is expected to complex As and form arsenopyrites under anaerobic conditions The zero valent iron is initially reduced to ferrous, with further reduction of the ferrous to ferric. The iron oxidation is typically concurrent with water hydrolysis, sulfate reduction and arsenate reduction. This results in ferric hydroxide, scorodite and arsenopyrites, among other species, which are insoluble and thus precipitate from solution. Oxidized iron is defined as the loss of electrons from elemental iron. This results in ferrous, upon loss of 2 electrons, or ferric iron, upon loss of 3 electrons. The oxidized iron may then combine with other ions in the water to form derivatives. For example, but not limited to, ferric oxide (rust), iron hydroxide, iron oxyhydroxide, pyrite and arsenopyrites.

The use of the binding system is not a definite application as implementation may occur in many ways. For example, but not limited to; In one embodiment, the binding system may be used in a filter form, whether pre-formed or in a container. In this situation the binding system will be placed and the contaminated aqueous stream will be passed through the binding system. The resulting aqueous stream, exiting the binding system will be contaminate free and can be directed as chosen by the user.

Another example, but not limited to, the binding system may be added to the contaminated aqueous stream, either batch or continuous. The binding system can then be separated after the removal of the target toxic metals by a variety of techniques, including, but not limited to, settling, filtration centrifugation. The resulting aqueous stream, after the binding system is removed, will be contaminate free and can be directed as chosen by the user.

Yet another example, but not limited to, the binding system may be injected directly into a ground water source that is contaminated by toxic metals, such as a contaminated aquifer. The toxic metals would be adsorbed to the binding material in situ and the natural geological structure creating the aquifer would filter the binding system with adsorbed toxic metals, thus immobilizing the toxic metals.

The binding system may also be constructed in many different forms and has no definite formula. The combination range of the volcanic rock, recycled minerals from anthropogenic brick, zero valent iron and precipitated ferric solution is flexible and based upon the levels of target toxic metal concentration, matrix and disposal logistics.

In one form the binding system is a volcanic rock, directly mined from ashflow tuffs, in a natural, fine particle form. This presents the great advantage of minimal processing of the fundamental material, reducing the overall material cost and so allowing the development of a economically usable material. The volcanic rock used in the initial investigations was rhyolite, although, based on prior art, andesites, basalts, dacites, pumice and trachytes will respond as well, if not better dues to increased content of iron oxide derivatives. This is assuming they are also directly mined from ashflow tuffs in a fine particulate form. The use of just the unmodified volcanic rock is desirable for, but not limited to, the treatment of low levels of contaminated aqueous solution at an economic cost resulting in material that will never fail the United States Environmental Protection Agency's Toxicity Characteristic Leachate Procedure.

In another form water, volcanic rock and zero valent iron, either in the form of micro-powder or iron filings, are mixed and aerated. The resulting solid binding system is separated and the material is heated at greater than 105° C. to dryness then re-wetted and then heated again at greater than 105° C. to dryness. This is repeated multiple times.

In another form a precipitated ferric solution and volcanic rock is mixed. The resulting solid product is separated and the material is heated at greater than 105° C. to dryness then re-wetted and then heated again at greater than 105° C. to dryness. This is repeated multiple times. The precipitated ferric solution is prepared from any soluble ferric salt or ferrous salt followed by oxidation. After dissolution of the iron salts the pH is adjusted to pH=10 using any common base, such as, but not limited to, sodium hydroxide. The resulting insoluble ferric complexes precipitate, however they are not separated from the aqueous phase, rather the solution is homogenized prior to mixing with the volcanic rock. After thorough mixing of the volcanic rock and the precipitated ferric solution, the solid binding system is separated and the material is heated to dryness.

In another form water, volcanic rock and zero valent iron, either in the form of micro-powder or iron filings, is mixed and aerated. The resulting solid product is separated and the material is heated at greater than 105° C. to dryness then re-wetted and then heated again at greater than 105° C. to dryness. This is repeated multiple times. The resulting dry product and a precipitated ferric solution is mixed. The resulting solid product is separated and the material is heated to dryness. The precipitated ferric solution is prepared from any soluble ferric salt or ferrous salt followed by oxidation. After dissolution of the iron salts the pH is adjusted to pH=10 using any common base, such as, but not limited to, sodium hydroxide. The resulting insoluble ferric complexes precipitate, however they are not separated from the aqueous phase, rather the solution is homogenized prior to mixing with the volcanic rock. After thorough mixing of the volcanic rock and the precipitated ferric solution, the solid binding system is separated and the material is heated to dryness.

In another form water, recycled minerals from anthropogenic brick and zero valent iron, either in the form of micro-powder or iron filings, is mixed and aerated. The resulting solid binding system is separated and the material is heated at greater than 105° C. to dryness then re-wetted and then heated again at greater than 105° C. to dryness. This is repeated multiple times.

In another form a precipitated ferric solution and recycled minerals from anthropogenic brick are mixed. The resulting solid product is separated and the material is heated at greater than 105° C. to dryness then re-wetted and then heated again at greater than 105° C. to dryness. This is repeated multiple times. The precipitated ferric solution is prepared from any soluble ferric salt or ferrous salt followed by oxidation. After dissolution of the iron salts the pH is adjusted to pH=10 using any common base, such as, but not limited to, sodium hydroxide. The resulting insoluble ferric complexes precipitate, however they are not separated from the aqueous phase, rather the solution is homogenized prior to mixing with the volcanic rock. After thorough mixing of the volcanic rock and the precipitated ferric solution, the solid binding system is separated and the material is heated to dryness.

In another form water, recycled minerals from anthropogenic brick and zero valent iron, either in the form of micro-powder or iron filings, is mixed and aerated. The resulting solid product is separated and the material is heated at greater than 105° C. to dryness then re-wetted and then heated again at greater than 105° C. to dryness. This is repeated multiple times. The resulting dry product and a precipitated ferric solution is mixed. The resulting solid product is separated and the material is heated to dryness. The precipitated ferric solution is prepared from any soluble ferric salt or ferrous salt followed by oxidation. After dissolution of the iron salts the pH is adjusted to pH=10 using any common base, such as, but not limited to, sodium hydroxide. The resulting insoluble ferric complexes precipitate, however they are not separated from the aqueous phase, rather the solution is homogenized prior to mixing with the volcanic rock. After thorough mixing of the volcanic rock and the precipitated ferric solution, the solid binding system is separated and the material is heated to dryness.

In one example (binding system formulation A) the binding system is a volcanic rock or recycled minerals from anthropogenic brick are directly mined from ashflow tuffs in a fine particle form.

In another example (binding system formulation B) a 35:7:1 ratio, by weight, of water, volcanic rock, or recycled minerals from anthropogenic brick, and zero valent iron, either in the form of micro-powder or iron filings, is mixed and aerated. The resulting solid binding system is separated and the material is heated at greater than 105° C. to dryness then re-wetted and then heated again at greater than 105° C. to dryness.

In another example (binding system formulation C) a 5:1 ratio, by weight, of a precipitated ferric solution and volcanic rock, or recycled minerals from anthropogenic brick, is mixed. The resulting solid binding system is separated and the material is heated at greater than 105° C. to dryness then re-wetted and then heated again at greater than 105° C. to dryness.

In another example (binding system formulation D) a 35:7:1 ratio, by weight, of water, volcanic rock, or recycled minerals from anthropogenic brick, and zero valent iron, either in the form of micro-powder or iron filings is mixed and aerated. The resulting solid product is separated and the material is heated to dryness. A 1:5 ratio, by weight, of the resulting dry product and a precipitated ferric solution is mixed. The resulting solid binding system is separated and the material is heated at greater than 105° C. to dryness then re-wetted and then heated again at greater than 105° C. to dryness.

In another example (binding system formulation E) a 3:5 ratio by weight of precipitated ferric solution and volcanic rock, or recycled minerals from anthropogenic brick, is mixed. The resulting solid product is separated and the material is heated to dryness. The dry binding system is rinsed with water until the run-off is clear and then heated at greater than 105° C. to dryness then re-wetted and then heated again at greater than 105° C. to dryness.

TABLE 1
Percentage removal efficiencies of arsenic species
using binding system formulations A, C and D

| Arsenic Species | A | C | D |
|---|---|---|---|
| Arsenite | 51.5% | 99.8% | 99.7% |
| Arsenate | 50.7% | 24.0% | 98.7% |
| Organic bound | 17.7% | Not Tested | 77.3% |
| arsenic | | | |

Table 1 reports the amount of arsenic species absorbed from a contaminated aqueous solution by the binding system formulations A, C and D. The contaminated aqueous solution contained 1000 μg/L of arsenite, 1000 μg/L of arsenate and 1000 μg/L of organic bound arsenic. 2 g of the binding system being studied was placed in a test column. 125 mL of the contaminated arsenic solution was passed through the column, with an allowed detention time of 10 minutes. The resulting effluent was collected and analyzed for remaining arsenic. Binding system formulation A removes 51.5%, 50.7% and 17.7% of the arsenite, arsenate and 1000 μg/L of organic bound arsenic, respectively. Binding system formulation C is a modification of binding system formulation A with the precipitated ferric solution. This modification results in an increase in arsenite removal to 99.8%. However, the amount of arsenate removed is reduced to 24.0%. Organic bound arsenic was not monitored for binding system formulation C in this experiment. Binding system formulation D is a modification of binding system formulation A with zero valent iron and the precipitated ferric solution. Binding system formulation D removes 99.67% of arsenite, 98.68% of arsenate, a significant improvement on binding system formulation C and 77.3% of the organic bound arsenic.

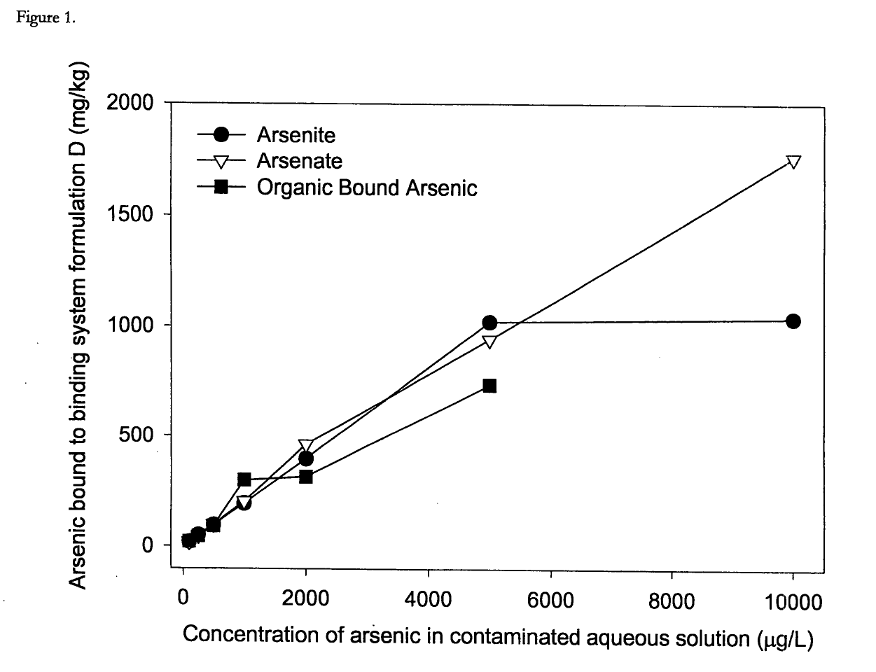

FIG. 1 demonstrates the amount of arsenic that can be bound to binding system formulation D. Individual contaminated aqueous solutions were made containing 100, 250, 500, 1000, 2500, 5000 and 10000 μg/L of arsenite and arsenate and 100, 250, 500, 1000, 2500, and 5000 μg/L of organic bound arsenic. 5 g of binding system formulation D was placed in a number of test columns and 125 mL of a contaminated aqueous solution contaminated with different arsenic species was passed through each column, with an allowed detention time of 10 minutes. There is no observable saturation of binding system formulation D by organic bound arsenic compounds up to 5000 μg/L of organic bound arsenic in the contaminated aqueous solution. There is also no observable saturation of binding system formulation D by arsenite compounds up to 10000 μg/L of arsenite in the contaminated aqueous solution. Between 5000 and 10000 μg/L of arsenate in the contaminated aqueous solution, saturation of binding system formulation D is observed. This is indicated by the 5000 and 10000 μg/L data points for arsenate contaminated aqueous solution resulting in a similar amount of arsenic bound to binding system formulation D.

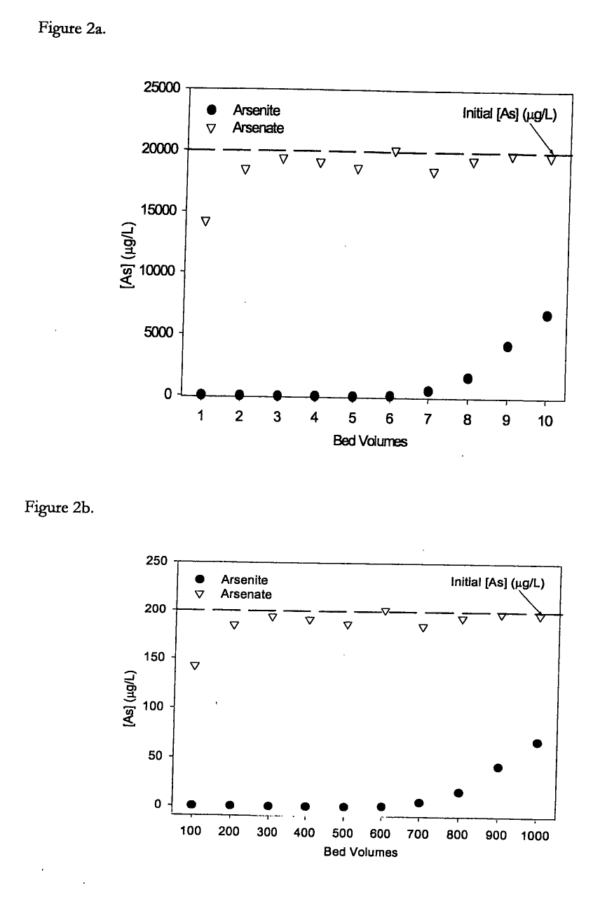

Two filter beds containing binding system formulation C were constructed. Two aqueous solutions were deliberately contaminated with either 20000 μg/L of arsenite or 20000 μg/L of arsenate. The contaminated solutions were passed through the binding system formulation C filter beds. Unit bed volumes of effluent were collected separately and analyzed for arsenic contamination. FIGS. 2a and 2b demonstrate the breakthrough curve for arsenite and arsenate contaminated aqueous solutions as they are passed through the binding system formulation C filter bed. FIG. 2b translates the results from FIG. 2a into the equivalent data assuming that the contaminated aqueous solution was 200 μg/L arsenite or arsenate, a typical arsenite and arsenate concentration found in a contaminated environment. It can be seen in FIG. 2a that in 3 bed volumes of contaminated aqueous solution arsenate has completely broken through the filter and the effluent returns to 20000 μg/L arsenic. However, the arsenite only starts to indicate column breakthrough at 7 bed volumes of contaminated aqueous solution.

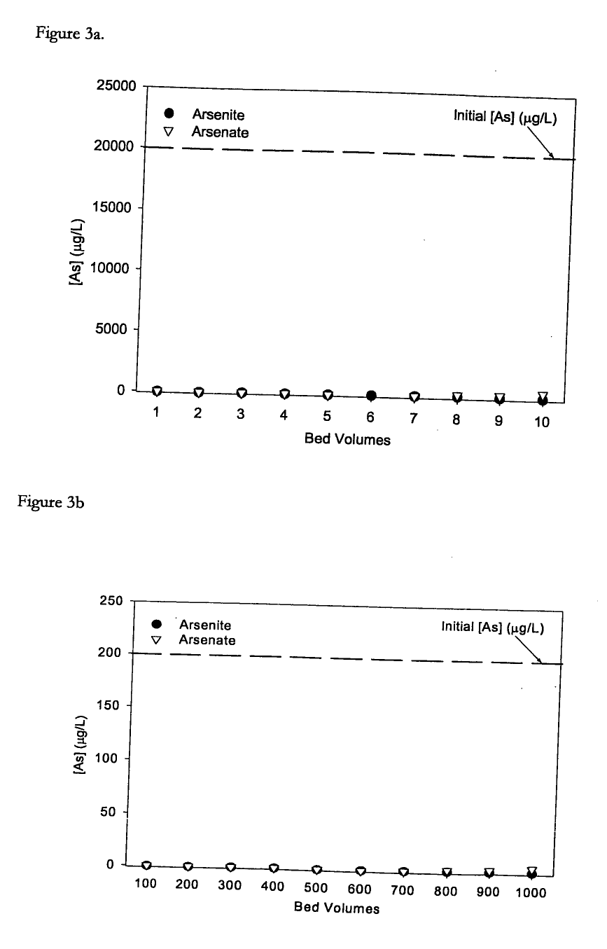

Two filter beds containing binding system formulation D were constructed. Two sets of municipal wastewater were deliberately contaminated with either 20000 μg/L of arsenite or 20000 μg/L of arsenate. The contaminated wastewaters were passed through the binding system formulation D filter beds. Unit bed volumes of effluent were collected separately and analyzed for arsenic contamination. FIGS. 3a and 3b demonstrate the breakthrough curve for arsenite and arsenate wastewaters as they are passed through the binding system formulation D filter bed. FIG. 3b translates the results from FIG. 3a into the equivalent data assuming that the contaminated aqueous solution was 200 μg/L arsenite or arsenate, a typical arsenite and arsenate concentration found in a contaminated environment. It can be seen in FIG. 3a that in 10 bed volumes of 20000 μg/L contaminated municipal wastewater (the equivalent of 1000 bed volumes of 200 μg/L contaminated aqueous solution) no significant breakthrough of arsenite or arsenate can be observed.

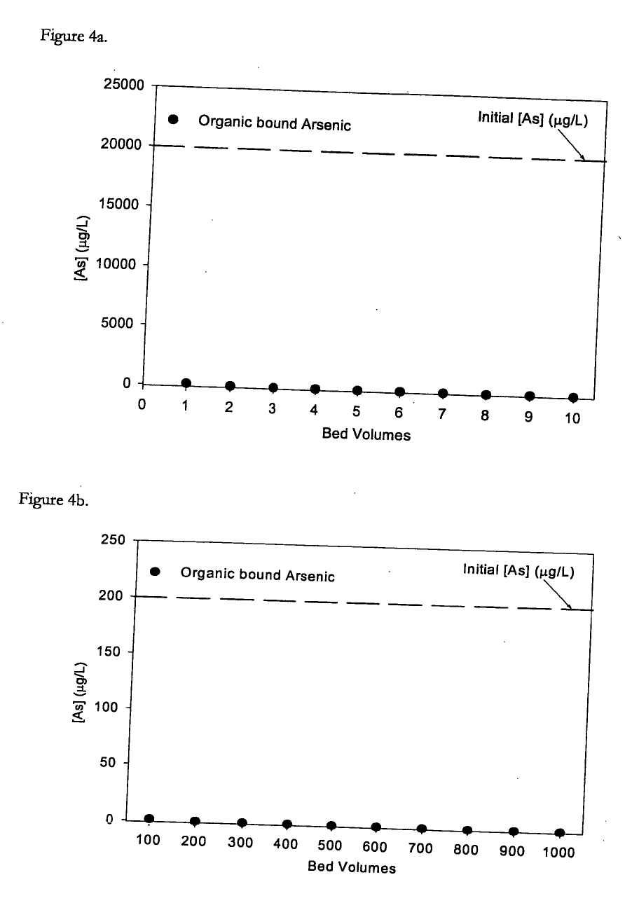

A filter bed containing binding system formulation E was constructed. Municipal wastewater was deliberately contaminated with either 20000 μg/L of organic bound arsenic. The contaminated wastewater was passed through the binding system formulation E filter bed. Unit bed volumes of effluent were collected separately and analyzed for arsenic contamination. FIGS. 4a and 4b demonstrate the breakthrough curve for the organic bound arsenic aqueous solutions as they are placed in contact with binding system formulation E. FIG. 4b translates the results from FIG. 4a into the equivalent data assuming that the contaminated aqueous solution was 200 μg/L arsenite or arsenate, a typical organic bound arsenic concentration found in a contaminated environment. It can be seen in FIG. 4a that in 10 bed volumes of 20000 μg/L contaminated municipal wastewater (the equivalent of 1000 bed volumes of 200 μg/L contaminated aqueous solution) no significant breakthrough of organic bound arsenic can be observed.

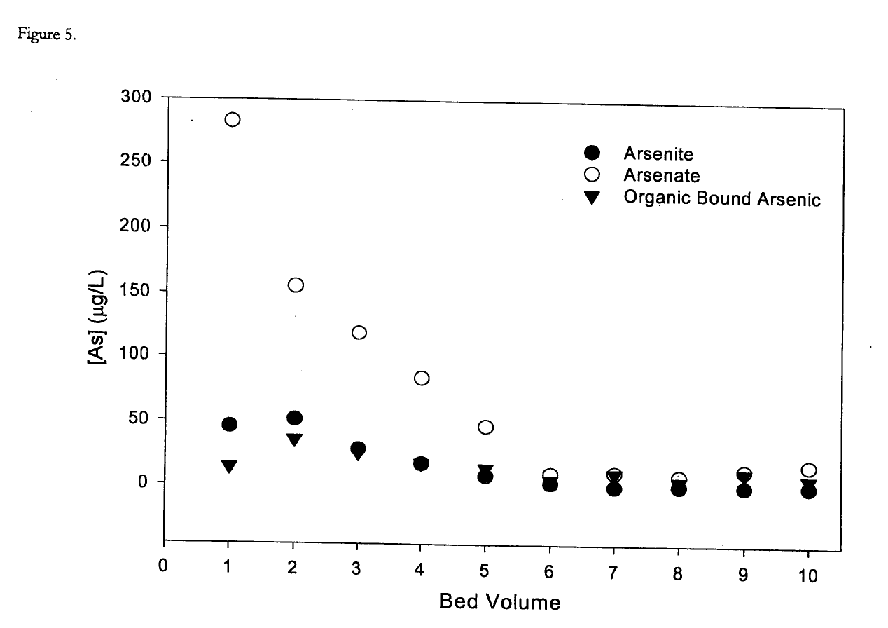

FIG. 5 demonstrates the concentrations of arsenic observed in the effluent of a binding during a column rinse with >18 megaohm water (ultra pure water). Prior to the rinse a binding system formulation D filter unit was saturated with arsenite, arsenate and organic bound arsenic. The rinse water was passed through the filter unit and unit bed volumes of effluent were collected separately and analyzed for arsenic contamination. It is observed, that even in the worse case scenario of arsenate, by 6 bed volumes all of the species are of negligible concentration in the effluent.

TABLE 2
Data generated from the toxicity characteristic leachate procedure
(US EPA Method 1311) for binding system formulation D, examining
arsenic species, the regulatory limit is 5 mg/L

| | TCLP Concentration |
|---|---|
| Arsenic Species | (mg/L) |
| Arsenite | 0.08 |
| Arsenate | 0.22 |
| Organic bound | 0.91 |
| arsenic | |

Table 2 reports the concentrations of arsenic observed in the leachate from the toxicity characteristic leachate procedure (US EPA Method 1311). In response to this Congressional mandate, EPA developed, in 1986, a new test—the Toxicity Characteristic Leaching Procedure (TCLP). Given Congressional concerns, EPA's primary focus in developing the TCLP was to satisfy two objectives: 1) to create a test that would generate replicable results for organics, and 2) to create a test that would yield the same results for inorganics as the original EP test. The test simulates the amount of toxic metal that may be leached from a municipal landfill should a toxic metal saturated material be placed in landfill. If the concentration of toxic metal in the material does not exceed the TCLP regulated value, for example the TCLP regulated value for arsenic is 5 mg/L. The data in Table 2 was generated by saturating a filter bed of binding system formulation D with either arsenite, arsenate or organic bound arsenic. The saturated binding system formulation D is then processed according to US EPA Method 1311. It can be seen that even the highest concentration of arsenic found in the TCLP leachate, that of the organic bound arsenic, is significantly below the regulated 5 mg/L concentration.

1. A material for the remediation of toxic metal species from contaminated aqueous solutions containing a modified volcanic rock wherein:
the volcanic rock is modified by mixing it with zero valent iron and oxidized iron derivatives,
the modified volcanic rock heated at greater than 105° C. to dryness.

2. The material in accordance with claim 1, where the material, after heating to dryness once, is re-wetted and heated at greater than 105° C. to dryness multiple times.

3. The material in accordance with claim 1, where the volcanic rock is from the group containing andesites, basalts, dacites, pumice, rhyolites and trachytes.

4. The material in accordance with claim 1, where the varying amounts of zero valent iron and oxidized iron derivatives are homogenized or layered with the volcanic rock.

5. The material in accordance with claim 1, where it removes toxic metal species from the groups metals, metalloids, other metals and the associated organic complexes of the toxic metals.

6. The material in accordance with claim 1, where it has the aqueous stream is passed over or through it.

7. The material in accordance with claim 1, where it is added to the contaminated aqueous solution.

8. The material in accordance with claim 1, where it is added in situ to groundwater.
